(19) United States
(12) Patent Application Publication
(10) Pub. No.: US 2024/0406074 A1
(43) Pub. Date: Dec. 5, 2024

(54) COMMUNICATIONS NETWORK CONTROL PLANE PROCESS

(71) Applicant: MICROSOFT TECHNOLOGY LICENSING, LLC, Redmond, WA (US)

(72) Inventors: Charumati Lakshmi Kavya BASUTI, Hyderabad (IN); Bhuvaneshwari Kumar IYER, Hyderabad (IN); Soumitra BANERJEE, Hyderabad (IN); Kiran GADWALA, Hyderabad (IN); Calum Sutherland LOUDON, Edinburgh (GB); Peter Louis WHITE, Edinburgh (GB); Harish Kumar CHANDRAPPA, Bothell, WA (US); Vikrant ARORA, Noida (IN)

(21) Appl. No.: 18/212,286

(22) Filed: Jun. 21, 2023

(30) Foreign Application Priority Data
Jun. 2, 2023 (IN) 202311037924

(51) Int. Cl. H04L 47/70; H04L 67/51

(52) U.S. Cl. CPC H04L 41/14; H04L 41/084; H04L 41/145; H04L 41/147; H04L 67/51

(57) ABSTRACT

A process performed by a control plane of a communications network. The control plane receives a request, the request comprising a network service design template specifying a communications network service to be deployed at a specified set of physical resources using a plurality of network functions and cloud functionality. Prior to deployment of the communications network service, the control plane interprets the network service design template and determines resources of the communications network that would be used for deploying the communications network service per the received request. The control plane returns details of these resources.

### PRIORITY APPLICATION

This application claims priority to Indian patent application No. 202311037924, filed on Jun. 2, 2023, the content of which application is expressly incorporated herein by reference in its entirety.

### BACKGROUND

Communications networks running in a cloud environment comprise of a series of network services, connected in a computer network. Cloud environments themselves comprise sets of networked physical computational resources, that are orchestrated by control plane functionality, responsible for instantiating, and managing network services such as 4G or 5G telecommunications network services.

### SUMMARY

The following presents a simplified summary of the disclosure in order to provide a basic understanding to the reader. This summary is not intended to identify key features or essential features of the claimed subject matter nor is it intended to be used to limit the scope of the claimed subject matter. Its sole purpose is to present a selection of concepts disclosed herein in a simplified form as a prelude to the more detailed description that is presented later.

In the present disclosure is a process performed by a control plane of a communications network. The control plane receives a request, the request comprising a network service design template specifying a communications network service to be deployed at a specified set of physical resources using a plurality of network functions and cloud functionality. Prior to deployment of the communications network service, the control plane interprets the network service design template; and determines resources of the communications network that would be used for deploying the communications network service per the received request. The control plane returns details of these resources.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a schematic diagram illustrating a request response flow performed by a control plane.

FIG. 2 is a flow diagram of a method implemented by a control plane.

FIG. 3 is a schematic diagram of possible sub elements of a request.

FIG. 4 is a schematic diagram of possible sub elements of a response.

FIG. 5 is a schematic diagram of elements involved in creating a network service.

FIG. 6 is a schematic diagram illustrating the elements of the request that the operator provides.

FIG. 7. is a schematic diagram illustrating a method of interpreting a design template performed by a control plane.

FIG. 8 illustrates an exemplary computing-based device in which examples of the disclosure are implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present examples are constructed or utilized. The description sets forth the functions of the examples and the sequence of operations for constructing and operating the examples. However, the same or equivalent functions and sequences may be accomplished by different examples.

Although the present examples are described and illustrated herein as being implemented in a telecommunication network, the system described is provided as an example and not a limitation. As those skilled in the art will appreciate, the present examples are suitable for application in a variety of different types of communication networks implemented in cloud environments.

A method of network operators deploying network services to create a desired communication network is through combining one or more Network Service Design (NSD) Templates with optional configuration specific to a specific network operator, and then using a control plane to instantiate the resulting network services at a specified set of physical resources in the cloud environment.

The operators of these communications networks are often not involved in the creation of the NSD Templates, and it is expected by the network designers who create these NSD Templates that one NSD Template is to be used by multiple operators with different specific configurations. Creating, testing, and updating these NSD Templates is often difficult, expensive, and time consuming due to the wide variety of configurations that operators use. Furthermore, some NSD Templates include other templates within themselves, so an operator instantiating one template unexpectedly results in several complex and resource intensive network services being instantiated, or significant changes being unexpectedly made to existing networks, unless operators spend time carefully investigating each change. As a result, operating these networks also has a significant overhead, even with the advantage offered to the operators by using NSD Templates which specify the network services.

In the described examples, components of a telecommunications system are created/curated by distinct users. Two roles are of particular importance: Designer and Operator. A single role, referred to as a Designer in the description, is responsible for creating network service design templates. A single role, referred to as an Operator in the description, operates a specific instance of a network service, and does not design the network services employed, however is responsible for specific configuration (specific config) of an instance of a network services design. An operator is able to create a specific Site Network Service (SNS) through a combination of a specified set of physical resources in a cloud (a Site), and an available network service design template. An Operator interacts with a communications network via an Operator Interface, which allows them to instruct a control plane to perform various actions to manage and orchestrate the cloud network.

Difficulties emerge with this separation of functions. The Operator often has limited control over the infrastructure that comprises the cloud environment, and the contents of the network service design templates. Thus, when deploying a specific instance of a network service design template, they cause unexpected changes or additions to their network as the network service design template is of a larger scope than expected, or requires an unexpectedly large number of supporting network services. This causes wasted computational power, cost, or a network outage. Equally, the Designer of network services benefits from validating their network service design templates against many possible configurations and sets of physical resources, however is unable or unwilling to create large numbers of test specific networks due to the waste of resources these test environments represent. The present technology provides ways to mitigate or ameliorate these difficulties by enabling network service design templates and optionally specific configurations to be interpreted prior to deployment. Resources of the communications network to be used for deployment are determined prior to deployment. In this way resources efficiencies are gained and accuracy is improved such as during deployment of communications network services. This is possible even where network service design templates are opaque to operators.

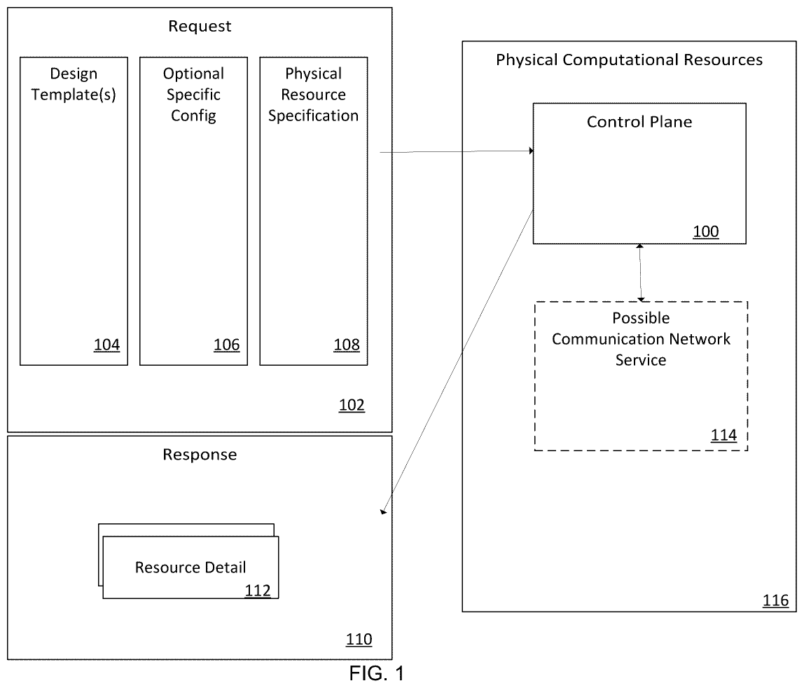

FIG. 1 is a schematic diagram illustrating a control plane apparatus, and a diagrammatic representation of the request and response messages that are sent and received by the control plane.

A control plane is the part of cloud infrastructure which manages and orchestrates network functions that, together with the cloud infrastructure, make up a cloud network. A cloud network is a specific communications network comprised of a plurality of networked physical resources, upon which cloud infrastructure is run to allow further communications network services to run on this cloud network, each using a portion of the underlying networked physical resources. One control plane can run across a plurality of sets of networked physical resources, allowing further communications network services to be deployed across the entirely of the cloud.

In this diagram, the control plane, 100, is running as part of a cloud network which includes physical computational resources, 116, upon which the control plane is running. A non-exhaustive list of examples of physical computational resources is processors, memories, controllers, network interfaces, and input or display devices. In a cloud, many computational devices comprising these physical computational resources are networked to create a virtual pool of computational processing power, storage, and network throughput. These physical resources are often grouped into distinct geographic locations, such as physical datacenters owned and operated by cloud providers or service providers, or logical groupings of computational resource that a network operator has access to. These may be thought of as “sites”, being either physical or logical groupings of resources where network services may be deployed. A Telecommunication Network Service, 114, is optionally instantiated on the physical computational resources.

The control plane receives a request, from a requestor. Requestors may be, for example, a user or administrator of the cloud network, a customer of a cloud network provider, an Operator using an Operator Interface, or a Designer, 102. The request comprises several sub elements including an NSD Template, 104: optionally some specific config. 106; and a specification of some physical resources to use, 108. An NSD Template is a collection of elements which together define the structure of a class of network services. Such NSD templates may include references to the application logic that makes up the network function itself, specifications of classes of physical or cloud resources that would be needed to deploy the function, relations to other network services that must exist as part of the wider network, mappings to various configuration files required by the network function, and other elements that network devices of the specified class require. Specific config is an abbreviation of specific configuration, and means the elements of the network service that are specific to this individual instance of that network function, such as their internet protocol (IP) address, the IP addresses of connected elements, configuration for endpoints that the network function is responsible for interoperating with, configuration specifying desired behavior or network capabilities, and other elements that define the Operator's wider communications network. The request 102 can be said to specify a desired network service to instantiate. The request 102 is sent to the control plane 100 functionality. As the component that instantiates network services, the control plane 100 functionality is able to interpret the network service specification and determine how the possible resulting service would be instantiated, 114. The term “interpret” refers to computing how the possible resulting service may be instantiated. In some examples, this is done by pulling the information/templates specified in the network service design NSD and combining it with physical resources information provided by an operator. Optionally specific configuration information is also combined. The control plane processes the collective information and a set of validations may be done. A resulting list of resources is returned to an operator.

In normal operation when managing a cloud network, the control plane, 100, would interpret such a request, 102, and instantiate one or more communications network services per the specification. The term “normal operation” means the behavior of the control plane when it is orchestrating the cloud network. However, in the present disclosure, the control plane 100 interprets the request but does not instantiate the possible communications network service. The control plane may be instructed to do this by elements in the request, be configured such that requests from specific interfaces are handled in this way, or through some other communication channel to instruct it to handle requests according to the present disclosure. Instead, the control plane generates and sends a response, 110, comprising details of the resource that would be used to instantiate the services. The requestor is thus able to examine the proposed resources, and use this information to determine whether the resulting network would be desirable to instantiate. The requestor is thus optionally able to then send further instructions to the control plane 100 to either instantiate the specified network services, or to cancel the request 102 without performing the instantiation. In some examples, the requestor is an automated process and the requestor automatically triggers instructions to be sent to the control plane to control the communications network.

As the control plane 100 is the part of the cloud network that instantiates and manages network services on the physical resources of the network, it is well placed to both interpret the request, 102, and generate the response, 110. Furthermore, this method is compatible with existing control plane implementations, as, in order to function as control planes, these elements of the cloud infrastructure already interpret network service specifications for the purpose of instantiating these services. The control plane 100 also has the capability to interrogate the underlying cloud environment to determine the resources to be employed as the element of the cloud network capable of managing and administering the network services deployed in the cloud network.

FIG. 1 illustrates a request 102 and response 110 relating to a communications network service. A variety of communication network services are possible, including telecommunication inner network elements deployed by service providers to support traditional cloud based wireline processing, telecommunication network elements to support 3rd Generation Partnership Project 4th Generation mobile networks, and/or 5th Generation mobile networks. As these latter networks are designed in a format easy to deploy in the cloud, network services comprising these networks are likely to be deployed in cloud environments. Furthermore, other communications network services could also comprise a number of network functions deployed in a cloud environment. The request and response depicted in FIG. 1 are generally applicable to any network service deployed on cloud based physical resources using a control plane.

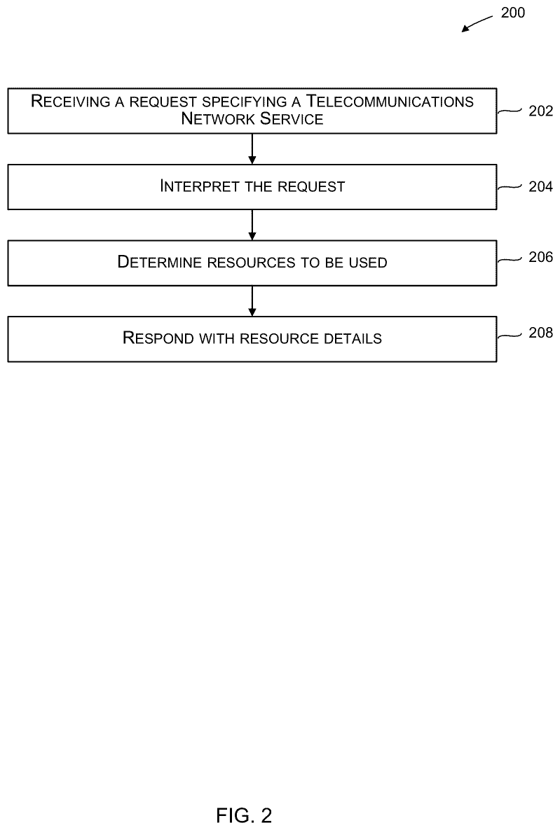

FIG. 2 consists of a flow chart, showing in more detail the method, 200, performed by the control plane. The method starts by a control plane receiving. 202, a request specifying a communications network service, and then proceeds to interpret, 204, the request. This results in the control plane determining a list of the resources that would be used if the request were to be acted upon, 206. Once this list of the resources that would be used is determined, the response is sent with this list of the resources that would be used, 208, for display at a user interface in some examples.

Though FIGS. 1 and 2 provide a clear illustration, as would be apparent to the skilled person, in practice the requests and responses are more complex. The request may include multiples of each element, and thus the response could include a plurality of different sets of resource details to be compared by the requestor. Furthermore, elements could be combined and provided in various configurations, such as each network service design template comprising a sub section which is specific configuration for that network service design template, or the specific configuration and physical resource specification being combined into a single Site Network Service specification which is combined with a network service design template.

Furthermore, the network service design template, optional specific configuration, or physical resource specification may each comprise multiple elements that together deploy a complex network service comprised of multiple interrelated communications network services. The response is complex including details of many different resources that would be employed if the system was to be instantiated.

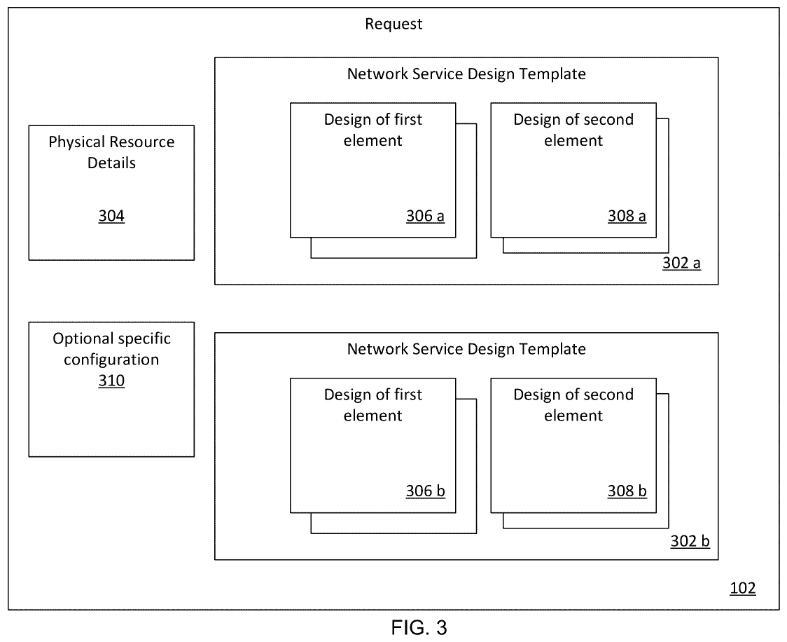

FIG. 3 illustrates the request comparing two complex network service design templates 302a, 302b. There is a request, 102, with a first network service design template, 302a and second network service design template 302b and physical resource details 304 and optional specific configuration 310. Each of these network service design templates, 302a and 302b, has a design of a first element 306a, 306b and a design of a second element 308a, 308b. The first element and the second element are any of: a network service design, a network function, a resource management template. The first element can be nested. The second element can be nested. That is, the first or second element comprise further nested design templates in some cases, where a design template is a network service design template, a network function template or a resource management template. Even though the designs are extremely complex with lots of nesting it is possible to compare them using the processes described herein in an efficient manner.

The microservice architecture that is common in cloud environments supports deploying a single large set of communication network function as a collection of smaller elements, and this in turn can add to the complexity faced by both the Designer and the Operator when deploying communication networks.

As would also be apparent to the skilled person, one or more of the elements within a request could be varied whilst others remain the same, allowing for a response to report the resources for a single design template (note that the term “design template” is used herein to mean “networks service design template”. to be deployed with different configurations, or across different sets of physical resources: or for competing design templates to be compared with identical configuration.

It should also be noted that the request, 102, could specify possible communications network services, 114, that are intended to form a new network, or services that are intended to be deployed as changes to or additions to an existing, already operating communications network. In the latter case, the response reports on both additional resources that would be employed, and resources that would no longer be used if the specified change was made.

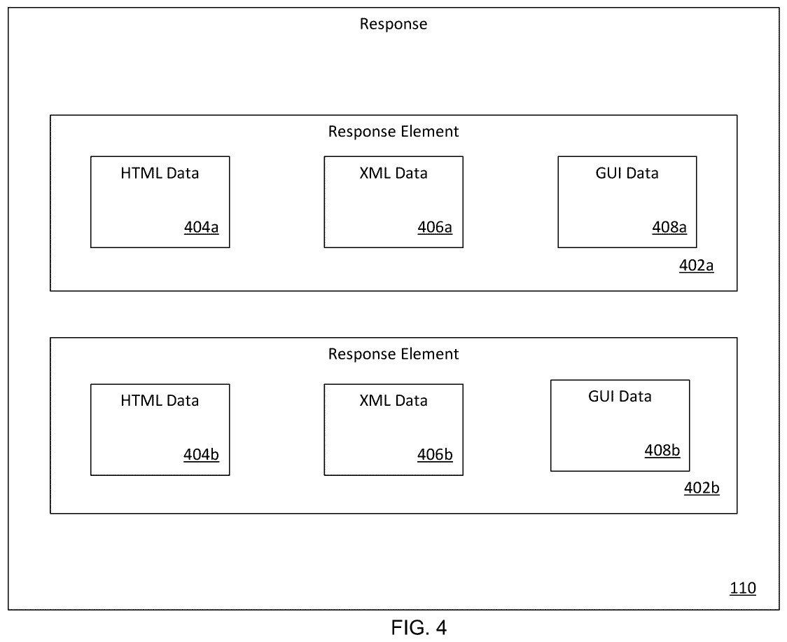

FIG. 4 shows elements present in a response, 110. In this response, there are a plurality of response elements, 402a and 402b. These correspond to different request elements specifying different communications network services, 302a and 302b, for example. In this example, the response includes data in a variety of formats for the user to interpret, including a Hyper-Text Markup Language (HTML) data element, 404, that is suitable for display on a web page, an extensible Markup Language (XML) data element, 406, that is to be programmatically interpreted, and an element in a proprietary format for display on a Graphical User Interface (GUI), 608. Each of these elements include data on the resources to be used by the communications network service specified. This could be a simple set of resources, or a complex list which comprises many different resources depending on the complexity of the communications network service. As would be apparent to a skilled person, it is unlikely for a response in practice to contain all these elements as it is likely each implementation would select the one appropriate for the service displaying the response. In practice, this could be a webpage, a GUI, a commerce system for deploying cloud based components, a dashboard showing a series of performance graphs, or as the response comprised of human readable data.

The data that is included in elements 404, 406, and 408 is anything of use to evaluate or compare the two network service specifications. This could include a list of communications network services that will make up the resulting network, the energy cost of those elements, the estimated computation and memory requirements of the various network services, any risks matching pre-defined characteristics, or estimated latency based on the specified physical elements connectivity to other network elements. Furthermore, the method is configured to highlight, in the details returned in the response, specific maximized or minimized elements. In some examples the method highlights which of several network specifications produces the maximum efficiency of certain resources, such as, the minimum computational power entailed for environmental reasons, or the minimum monetary cost, or compare the physical resource availability versus latency of several specified sites. As different elements can be varied to be compared, comparison is possible for both variable NSD Templates, specific config, or physical resources, or some combination of the above, for example selecting a different NSD Template from those intended for specific physical resources to compare two possible optimal configurations.

In addition to highlighting the specific maximal or minimal values in the response, the response optionally compares various different specified sets of physical resources and recommends which combination of physical resources delivered appropriate service, based on a previous specified metric or measure. For example, if a control plane is configured or the request specified that the output required a specific amount of network capacity be offered to a plurality of different end points, the request could comprise a deployment using one large set of physical resources in a centralized location and a deployment comprising multiple smaller deployments at sites geographically closer to the end points, and the response could recommend which of the configurations minimized processing power and memory usage whilst delivering the required capacity.

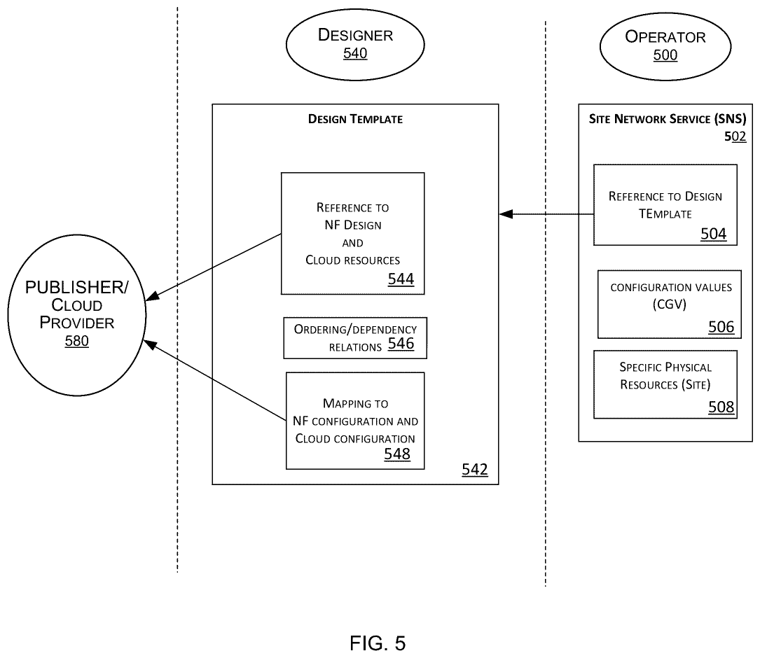

FIG. 5 illustrates the elements involved in creating a network service and gives more details on the possible requestor. In this diagram, there are two possible requestors, an Operator, 500, and a Designer, 540. The Operator, 500, is the administrator and operator of a telecommunications network, such as an internet service provider (ISP), or a telephone company. These groups will often be the groups that instantiate communications network services, and control the specific configuration values, 506, and will specify the desired physical resources to be used, 508, such as a physical site geographically proximate to their customers to reduce latency, or a cloud service that offers the functionality.

However, particularly for small to medium enterprises in this field, these entities often do not have a dedicated network function Designer. Often the network services they deploy are comprised of network services designed generally and made available as network service design templates via a catalog (such as an interface to a database or other store of design templates) to provide general function to Operators. The Designer, 540), creates these network service design templates, 542, defining the network function, and mapping them to underlying cloud resources, 544. They also map their specific design to other network service designs that the defined network function interrelates with, 546, or to underlying general network configuration, 548. The Operators do not access the details of the network service design template, and will simply include a reference, 504, to the network service design template that the Designer has created. This permits both easier deployment, more secure deployment, and for the Operator to focus expertise and resources elsewhere.

For completeness, there is further a cloud provider and Publisher, 580), which controls the underlying physical resources referenced by the Designer, 540.

Both the Designer and the Operator are users who may send requests to a control plane, as described above, for different purposes. The Operator, 500 would be expected to validate and compare specific possible deployments, without having either access to or the expertise to utilize the details of the network service design template, 542, that is outside of their area of focus. To the Operator, the NSD templates are “opaque”, as they ideally have limited insight into the elements that comprise it. Instead, they ideally select an NSD Template from a store or catalog of offered functions. This could be a bespoke catalog offered by a specific Designer to a specific Operator, or a public storefront offering various NSD Templates, such as the Azure (trademark) Marketplace. The Designer in turn wishes to test their network service design template with a variety of dummy configurations or sites, to ensure that the network service design establishes the specified network service correctly in a variety of use cases. In both cases, these entities would benefit from not incurring the cost of actually instantiating the network when they are simply validating the expected output. In the Operator's case, this prevents outages or errors caused by improperly changing a running network. In the Designer use case, the dummy configuration does not relate to real world entities, as the Designer is not actually administering a communications network, and so the specified network service is not actually possible to instantiate.

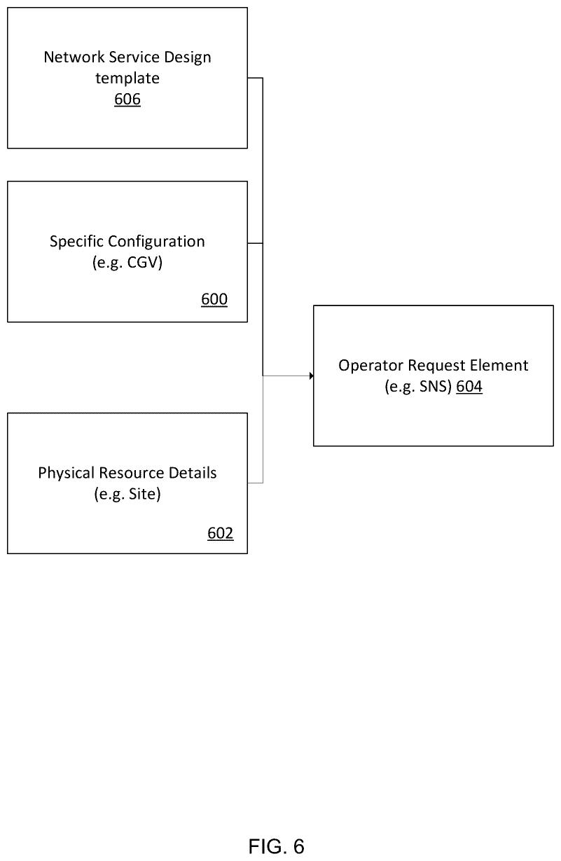

FIG. 6 is a schematic diagram illustrating the elements of the request that the Operator provides, and that may optionally be combined. In this diagram, an optional specific configuration, 600, is combined with the physical resource details, 602 and a network service design template 606 to form an operator request element 604. An operator may also provide a reference to a network service design template. In a specific example, the specific configuration, 600, may be a Configuration Group Values (CGV) file, and the physical resource details, 602, may be a specific cloud Site, and when combined with the network service design template 606 this would provide a Site Network Service (SNS) specification (such as 604 in FIG. 6) that includes the elements that the Operator would be expected to provide.

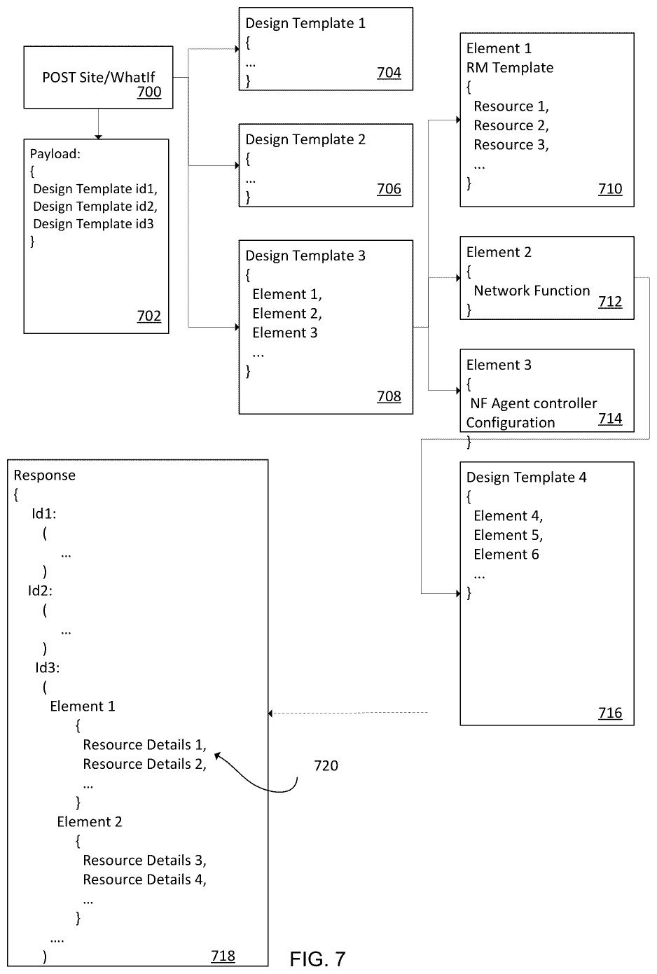

FIG. 7 is a schematic diagram illustrating a specific example of the method of interpreting the design template performed by the control plane. In this the method is entitled the “WhatIf” method, 700, and the request comprises a Hypertext Transfer Protocol (HTTP) POST request sent in relation to a specific cloud compute site. This request contains a payload, 702, which includes three network service design template IDs, 1, 2, and 3. The control plane receives this request, and interprets it, expanding the network service design templates to access the information they contain. Network Service Design Template 3, 708, in this example, contains several different elements. Element 1 is a Resource Manager (RM) template, 710, which specifies resources to be used. Element 3 contains network function agent controller configuration, 714, for this Network Service. Element 2 is a further network service design, specifying network service Design Template 4, which in turn contains multiple elements that would be interpreted as with the parent elements. This process is repeated for each of the provided network service design templates, 704, and 706. The control plane generates a response, 718, which provides resource details for each of the provided IDs in the original request. In this example, for network service Design Template 3, the response includes several sub elements, each of which contains a set of resource details for comparison, 720, by the requestor.

The benefits provided of implementing the invention on the control plane of a communications network are several fold. Firstly, as noted above, the control plane is able to both interpret the request and gather the data for the response. Secondly, the control plane of cloud networks tends to be deployed across multiple geographic or logical sets of physical resources (sites), and thus a single distributed control plane accesses the set of specified physical resources. The method includes a control plane receiving a request, which permits the method to be initiated by the requestor. The fact that this request is comprising a network service design template and a specific configuration, together specifying a communications network service, allows the Operator to provide the information they have access to in combination with a network design from a Designer or central catalog without generating the design themselves, and thus deploy networks cheaply and efficiently without compromising on the quality. Further allowing the request to specify that the service be deployed at a specified set of physical resources using a plurality of network services and cloud functionality permits this request to be sent both to deploy on sites in multiple geographic regions, for redundancy or latency reasons, without having to send either multiple requests or contact multiple control planes, and second allows a single request to compare multiple sites. Cloud functionality is any functionality accessible via the internet, intranet or other communications network cloud.

The running of the interpretation and resource determination operation prior to deployment of the communications network service allows the response to be generated, without deploying the network. This gives one or more of the following benefits: allowing errors to be corrected, deployments which permit more optimal use of computational resources to be chosen, different network design templates to be specified, or specific configuration to be supplied without resources being expended. The returning of details to the requestor forms the basis for these decisions or comparisons to be made, and deployment suspended or cancelled once the requestor has assessed the reply.

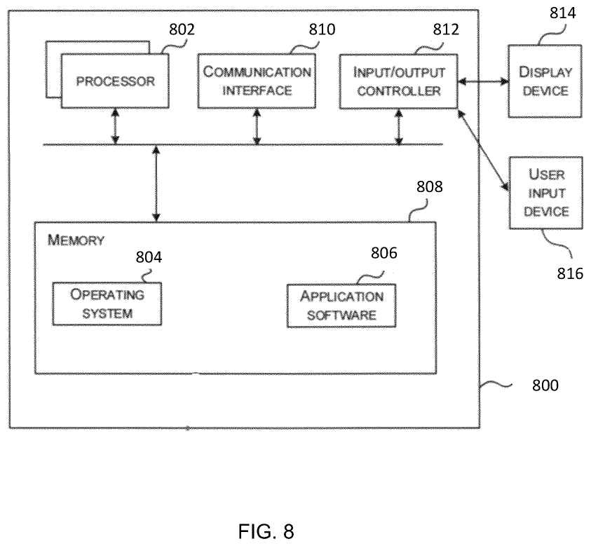

FIG. 8 illustrates various components of an exemplary computing-based device, 800, which are implemented as any form of a computing and/or electronic device, and in which embodiments of the control plane process are implemented in some examples.

Computing-based device, 800, comprises one or more processors, 802, which are microprocessors, controllers or any other suitable type of processors for processing computer executable instructions to control the operation of the device in order to form part of a cloud computing network, upon which runs a control plane. Platform software comprising an operating system, 804, or any other suitable platform software is provided at the computing-based device to enable application software, 806, to be executed on the device.

The computer executable instructions are provided using any computer-readable media that is accessible by computing based device, 800. Computer-readable media includes, for example, computer storage media such as memory, 808, and communications media. Computer storage media, such as memory, 808, includes volatile and non-volatile, removable and non-removable media implemented in any method or technology for storage of information such as computer readable instructions, data structures, program modules or the like. Computer storage media includes, but is not limited to, random access memory (RAM), read only memory (ROM), erasable programmable read only memory (EPROM), electronic erasable programmable read only memory (EEPROM), flash memory or other memory technology, compact disc read only memory (CD-ROM), digital versatile disks (DVD) or other optical storage, magnetic cassettes, magnetic tape, magnetic disk storage or other magnetic storage devices, or any other non-transmission medium that is used to store information for access by a computing device. In contrast, communication media embody computer readable instructions, data structures, program modules, or the like in a modulated data signal, such as a carrier wave, or other transport mechanism. As defined herein, computer storage media does not include communication media. Therefore, a computer storage medium is not to be interpreted to be a propagating signal per se. Although the computer storage media (memory, 808) is shown within the computing-based device, 800, it will be appreciated that the storage is, in some examples, distributed or located remotely and accessed via a network or other communication link (e.g. using communication interface, 810).

The computing-based device, 812, also comprises an input/output controller, 812, arranged to output display information to a display device, 814, which may be separate from or integral to the computing-based device, 800. The display information may provide a graphical user interface. The input/output controller, 812, is also arranged to receive and process input from one or more devices, such as a user input device, 816 (e.g. a mouse, keyboard, camera, microphone or other sensor). In some examples the user input device, 816, detects voice input, user gestures or other user actions and provides a natural user interface (NUI). This user input may be used to Create and send the request, or send the input. In an embodiment the display device, 814, also acts as the user input device, 816, if it is a touch sensitive display device. The input/output controller, 812, outputs data to devices other than the display device in some examples, e.g. a locally connected printing device (not shown in FIG. 8). Alternatively or in addition to the other examples described herein, examples include any combination of the following:

Clause A. A computer implemented method performed by a control plane of a communications network comprising receiving a request, the request comprising a network service design template specifying a communications network service to be deployed at a specified set of physical resources using a plurality of network functions and cloud functionality: prior to deployment of the communications network service, interpreting the design template: determining resources of the communications network to be used for deploying the communications network service: returning details of the determined resources.

Clause B. The method of clause A, wherein the request also comprises a specific configuration.

Clause C. The method of clause A or clause B, wherein the request is received from an operator interface of the communications network.

Clause D. The method of clause A or clause B or clause C, wherein, the network service design template is from a public catalog containing a plurality of network service design templates and the content of the network service design template is opaque to the operator.

Clause E. The method of any preceding clause further comprising, in response to an indication in the request, interpreting the network service design template and a dummy configuration; and wherein returning details of the resources comprises returning details of the network service design template.

Clause F. The method of any preceding clause, wherein the request additionally comprises a second network service design template, specifying a second communications network service to be deployed at a specified set of physical resources using a plurality of network functions and cloud functionality; and the details returned provide a comparison of the resources to be used for the first communications network service and resources to be used for the second communications network service.

Clause G. The method of any preceding clause wherein the method highlights in the details returned, which of the communications network services maximizes efficiency of a specified resource.

Clause H. The method of any preceding clause, wherein the communications network comprises a plurality of networked physical resources.

Clause I. The method of any preceding clause, wherein the control plane spans a plurality of cloud sites, each cloud site comprising a set of physical resources.

Clause J. The method of clause I, wherein the request specifies a plurality of sets of the physical resources: the details returned provide a comparison of the resources to be used for each of the sets of physical resources.

Clause K. The method of clause J wherein the comparison of the resources to be used includes a recommendation to deploy on a plurality of the sets of physical resources to maximize efficient usage of a specific resource.

Clause L. The method of clause K, wherein the request specifies a plurality of the sets of physical resources: the details returned provide a comparison of the resources to be used for each of the sets of physical resources.

Clause M. The method of any preceding clause, wherein the communications network service comprises multiple network services.

Clause N. The method of clause M, wherein the network service design template comprises: a design of a first element for use in a telecommunications network: a design of a second element for use in the telecommunications network; and the relationship between the first element and the second element: wherein the first element and the second element are any of: a network service design, a network function, a resource management template.

Clause O. The method of clause N, wherein the designs for the first or second element comprise further nested design templates.

Clause P The method of clause O, wherein the nested design templates are any of: network service design, network function template, resource management template.

Clause Q. The method of any preceding clause, wherein the communications network service is for use in a telephony network.

Clause R. The method of clause Q, wherein the telephony network is a third generation partnership project fifth generation 3GPP 5G mobile network.

Clause S. The method of any preceding clause, wherein the response is provided in a format suitable for presentation on a graphical user interface GUI.

Clause T. An apparatus comprising: a processor: a memory storing instructions that, when executed by the processor, perform a method comprising: receiving a request comprising a network service design template specifying a communications network service to be deployed at a specified subset of the physical resources using a plurality of network services and cloud functionality: prior to deployment of the communications network service, interpreting the network service design template: determining resources of the communications network to be used for deploying the service: returning details of the resources.

Clause U. A computer implemented method to deploy communications network services comprising: receiving a request at a control plane, the request comprising a network service design template and a specific configuration, together specifying a communications network service to be deployed at a specified set of physical resources using a plurality of network functions and cloud functionality, wherein the specific configuration is a dummy configuration: the control plane interpreting the network service design template and dummy configuration: the control plane determining resources of the communications network to support deployment of the service: the control plane returning details of the resources to the operator interface.

The term ‘computer’ or ‘computing-based device’ is used herein to refer to any device with processing capability such that it executes instructions. Those skilled in the art will realize that such processing capabilities are incorporated into many different devices and therefore the terms ‘computer’ and ‘computing-based device’ each include personal computers (PCs), servers, mobile telephones (including smart phones), tablet computers, set-top boxes, media players, games consoles, personal digital assistants, wearable computers, and many other devices.

The methods described herein are performed, in some examples, by software in machine readable form on a tangible storage medium e.g. in the form of a computer program comprising computer program code means adapted to perform all the operations of one or more of the methods described herein when the program is run on a computer and where the computer program may be embodied on a computer readable medium. The software is suitable for execution on a parallel processor or a serial processor such that the method operations may be carried out in any suitable order, or simultaneously.

Those skilled in the art will realize that storage devices utilized to store program instructions are optionally distributed across a network. For example, a remote computer is able to store an example of the process described as software. A local or terminal computer is able to access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a digital signal processor (DSP), programmable logic array, or the like.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The operations of the methods described herein may be carried out in any suitable order, or simultaneously where appropriate. Additionally, individual blocks may be deleted from any of the methods without departing from the scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the scope of this specification.

1. A computer implemented method performed by a control plane of a communications network, the method comprising:
receiving a request, the request comprising a network service design template specifying a communications network service to be deployed at a specified set of physical resources using a plurality of network functions and cloud functionality;
prior to deployment of the communications network service, interpreting the network service design template by computing how the communications network service can be instantiated using information pertaining to the network service design template and the specified set of physical resources, without instantiating the communications network service;
determining resources of the communications network to be used for deploying the communications network service; and
returning data indicative of details of the determined resources.

2. The method of claim 1, wherein the request also comprises a specific configuration.

3. The method of claim 1, wherein the request is received from an operator interface of the communications network.

4. The method of claim 2, wherein the network service design template is from a catalog containing a plurality of network service design templates and content of the network service design template is opaque.

5. The method of claim 1, further comprising, in response to an indication in the request, interpreting the network service design template and a dummy configuration; and wherein returning details of the resources comprises returning details of the network service design template.

6. The method of claim 1, wherein:
the communications network service is a first communications network service;
the request additionally comprises a second network service design template specifying a second communications network service to be deployed at a specified set of physical resources using a plurality of network functions and cloud functionality; and
the details returned provide a comparison of the resources to be used for the first communications network service and resources to be used for the second communications network service.

7. The method of claim 5, further comprising data indicative of highlights in the details returned as to which of the communications network services maximizes efficiency of a specified resource.

8. The method of claim 1, wherein the communications network comprises a plurality of networked physical resources.

9. The method of claim 1, wherein the control plane spans a plurality of cloud sites, each of the cloud sites comprising a set of physical resources.

10. The method of claim 9, wherein:
the request specifies a plurality of the sets of physical resources; and
the details returned provide a comparison of the resources to be used for each of the sets of physical resources.

11. The method of claim 10, wherein the comparison of the resources to be used includes a recommendation to deploy on a plurality of the sets of physical resources to maximize efficient usage of a specific resource.

12. The method of claim 1, wherein the communications network service comprises multiple network functions.

13. The method of claim 1, wherein the network service design template comprises:
a design of a first element for use in a telecommunications network;
a design of a second element for use in the telecommunications network; and
a relationship between the first element and the second element; wherein the first element and the second element are one of: a network service design, a network function, or a resource management template.

14. The method of claim 13, wherein the designs for the first or second element comprise further nested design templates.

15. The method of claim 14 wherein the nested design templates are one of: network service design, network function template, or resource management template.

16. The method of claim 1, wherein the communications network service is for use in a telephony network.

17. The method of claim 16, wherein the telephony network is a 3rd Generation Partnership Project 5th Generation (3GPP) 5G) mobile network.

18. The method of claim 1, wherein the data indicative of details is provided in a format suitable for presentation on a graphical user interface (GUI).

19. An apparatus comprising:
a processor;
a memory storing instructions that, when executed by the processor, cause the apparatus to perform operations comprising:
receiving a request comprising a network service design template specifying a communications network service to be deployed at a specified subset of physical resources using a plurality of network functions and cloud functionality;
prior to deployment of the communications network service, interpreting the network service design template by computing how the communications network service can be instantiated using information pertaining to the network service design template and the specified set of physical resources, without instantiating the communications network service;
determining resources of the communications network to be used for deploying the communications network service; and
returning details of the determined resources.

20. A computer implemented method for deploying communications network services, the method comprising:
receiving a request at a control plane, the request comprising a network service design template and a specific configuration, the request specifying a communications network service to be deployed at a specified set of physical resources using a plurality of network functions and cloud functionality, wherein the specific configuration is a dummy configuration;
prior to deployment of the communications network service, interpreting, by the control plane, the network service design template and dummy configuration by computing how the communications network service can be instantiated using information pertaining to the network service design template and the specified set of physical resources, without instantiating the communications network service;
determining, by the control plane, resources of the communications network to support deployment of the communications network service; and
returning, by the control plane, details of the resources to an operator interface.
